(19) United States
(12) Patent Application Publication
(10) Pub. No.: US 2010/0183384 A1
(43) Pub. Date: Jul. 22, 2010

(54) Machine tool and cutting ring for a machine tool

(76) Inventors: Jacek Kruszynski, Stuttgart (DE); Uwe Kretzschmann, Besigheim (DE); Erkan Hodza, Asperg (DE)

Correspondence Address: FLYNN THIEL BOUTELL & TANIS, P.C., 2026 RAMBLING ROAD, KALAMAZOO, MI, 49008-1631, US

(21) Appl. No.: 12/308,610

(22) PCT Filed: May 25, 2007
(86) PCT No.: PCT/EP2007/055087

§ 371 Date: Dec. 18, 2008

(30) Foreign Application Priority Data
Jun. 20, 2006 (DE) 10 2006 028 729.0

(51) Int. Cl. B23D 77/02; B23C 5/22

(52) U.S. Cl. 407/67; 407/102; 407/113

(57) ABSTRACT

The invention relates to a machine tool for use in tool machines, comprising a cutting element which is preferably configured as a cutting ring and at least two insert seats that are provided in the cutting element at distance to each other in the circumferential direction. The insert seats are fitted with at least one group of at least two identical insert tips that are detachably arranged therein and that have one working edge each, the effective working edges of the insert tips of one group being cut to the same nominal size. The insert tips are configured as indexable inserts, every single indexable insert of a group being associated with a defined insert seat in all possible positions of adjustment, and the indexable inserts of a group having at least two working edges each, one of these edges being always in the effective and at least one other edge being in the ineffective position, depending on the position of the indexable inserts in the associated insert seats. The indexable inserts of a group assume identical positions of adjustment in which defined working edges of every indexable insert of a group have the same orientation in the associated insert seat, the working edges of the indexable inserts of a group being cut to a nominal size in all common positions of adjustment.

The invention relates to a machine tool for use in tool machines, comprising a cutting body, at least two plate seats arranged at a distance from one another in the circumferential direction in the cutting body, and at least one group of at least one insert plate that is detachably arranged in the plate seats and that has at least one working edge, the at least one working edge of the at least one insert plate of a group being ground to a predefined nominal size. Further, the invention relates to a cutting body, realized as a cutting ring, for a machine tool.

Machine tools comprising cutting rings are intended mainly for reaming work for finish machining. In the case of known machine tools of this type, the insert plates, realized as cutting plates, are soldered into their plate seats. For the purpose of aligning the cutting rings, the procedure in such cases is as follows: Firstly, the cutting plates are soldered-on. The cutting ring, with its cutting plates, is then ground to a particular nominal size. In principle, the cutting plates can then still also be coated. In the grinding process, the working edges of the cutting plates, which are realized as cutting edges, acquire their individual cutting-edge shape. During a machining process, plate wear occurs in the region of the cutting edges, which plate wear renders a dimensional correction necessary from time to time. For this purpose, the cutting ring is dilated elastically over a central stretching mechanism. As soon as the dilation exceeds the elastic range, additional corrections must be performed. These include plastically dilating the cutting ring to oversize and subsequent finish grinding to machining size, and possibly re-coating of the cutting plates. This process is usually performed, not in the user's premises, but in the factory. Such a process can be repeated 5 to 10 times, until the cutting plates are worn out. Finally, the cutting plates are unsoldered from the cutting ring and replaced by new ones. There, the aforementioned processes are repeated. This process can also only be repeated to a limited degree, for example up to 10 times. A disadvantage of this procedure consists in that the soldering-on and unsoldering of cutting plates is resource-intensive, and the material properties are negatively affected by the temperature increase during soldering. The processes of plastically widening and soldering-on and unsoldering the cutting plates, and of subsequent regrinding to nominal size, can only be performed in the factory, which is likewise perceived as disadvantageous.

Proceeding therefrom, the invention is based on the object of so improving a machine tool of the type specified at the outset that both the production and the plate changing are facilitated, and that parts of these processes are transferred to the user.

For the purpose of achieving this object, there are proposed the feature combinations specified in claims 1 and 21. Advantageous developments and enhancements of the invention are disclosed by the dependent claims.

The solution according to the invention consists, in essence, in that the insert plates are realized as reversible plates, each individual reversible plate of a group is assigned to a defined plate seat in all positions of change, the reversible plates of a group each have at least two working edges, of which, depending on the position of the reversible plates in the associated plate seats, in each case one is in an operative position and at least one other is in a non-operative position, all reversible plates of the group assume corresponding positions of change, in which defined working edges of each reversible plate of the group have the same orientation within the associated plate seat, and the working edges of the reversible plates of the group are ground to nominal size in all common positions of change.

The reversible plates of a group can be realized in this case as cutting plates or as support plates, the working edges being realized as cutting edges in the case of the cutting plates and as support edges in the case of the support plates.

The aforementioned measures make it possible for reversible plate changing to be performed by the user himself, through simple manipulations, in the case of wear of a working edge. It must only be taken into account in this case that a “home plate seat” is assigned to each reversible plate, and that the working edges are numbered consecutively in the same manner within the reversible plates. In the case of reversible plate changing, all reversible plates must each assume the same position in their associated plate seat in respect of the orientation of their working edges. This means that all operative working edges of the reversible plates of a group must each bear the same identification or number.

In principle, it is possible also for a plurality of groups of reversible plates, having differing axial and/or radial alignments of their working edges, to be used in associated plate seats on a cutting body. It is accordingly proposed, according to a preferred development of the invention, that the cutting body have plate seats for at least one further group of reversible plates, the working edges of which, in their operative position of change, are ground to a nominal size. In this case, the reversible plates assigned to one another according to group are ground-over separately to their nominal size. The rearrangement of the reversible plates can be effected jointly or separately within different groups.

An advantageous development of the invention makes provision whereby the working edges of the reversible plates of a group are surface-coated in all common positions of change.

For the purpose of greater clarity in the change process, it is advantageous if the reversible plates of a group and the plate seats are identified in correspondence with their mutual assignment. Likewise, it is advantageous if the working edges of the reversible plates of a group are identified in respect of their mutual assignment.

According to a preferred development of the invention, the cutting body is realized as a cutting ring having plate seats arranged in a distributed manner over its circumference.

Advantageously, the reversible plates have the form of a prism, on whose lateral peripheries, which project, preferably perpendicularly, over a basic surface, the working edges are formed. A first embodiment variant in this case makes provision whereby the reversible plates have the form of a prism having a basic surface of an isosceles triangle. A further variant of the invention makes provision whereby the reversible plates have the form of a prism having a quadrangular, for example rectangular or square, basic surface. In the latter case, the mutually adjacent working-edges of the reversible plates are oriented such that they are laterally reversed in pairs in relation to one another.

A preferred development of the invention makes provision whereby the reversible plates are fixed to the cutting body, or cutting ring, by at least one headed screw, preferably realized as a countersunk-head screw. In the case of a first embodiment variant, the headed screws can be screwed into radially aligned threaded bores of the cutting body. In the case of a second embodiment variant, the headed screws are screwed into threaded bores of the cutting body that are aligned in the circumferential direction, while, in the case of a third embodiment variant, the headed screws are screwed into threaded bores of the cutting body that have an axially parallel alignment.

An additional adjustment possibility in the case of working edge wear is rendered possible in that the cutting body, realized as a cutting ring, has a central internal taper for the fitting of a tapered expansion tool. The cutting ring in this case expediently has support elements that complement one another to form an internal taper and that are assigned to the individual plate seats, and between which there are arranged elastically spreadable wall portions of lesser wall thickness that extend in the circumferential direction and that are assigned to individual chip grooves. There is additionally provided a spreading body, which clamps the cutting ring against a tool holder and bears against the support elements via an external taper. In this case, the clamping is expediently effected by means of a clamping nut, which can be screwed onto a central threaded stem that is solid with the tool holder and which thereby clamps the spreading body against the cutting ring.

The invention additionally relates to a cutting ring, comprising reversible plates, that has the properties according to the invention and that is intended to be detachably fastened to a machine tool for tool machines.

The invention is explained more fully in the following with reference to an exemplary embodiment represented schematically in the drawing, wherein

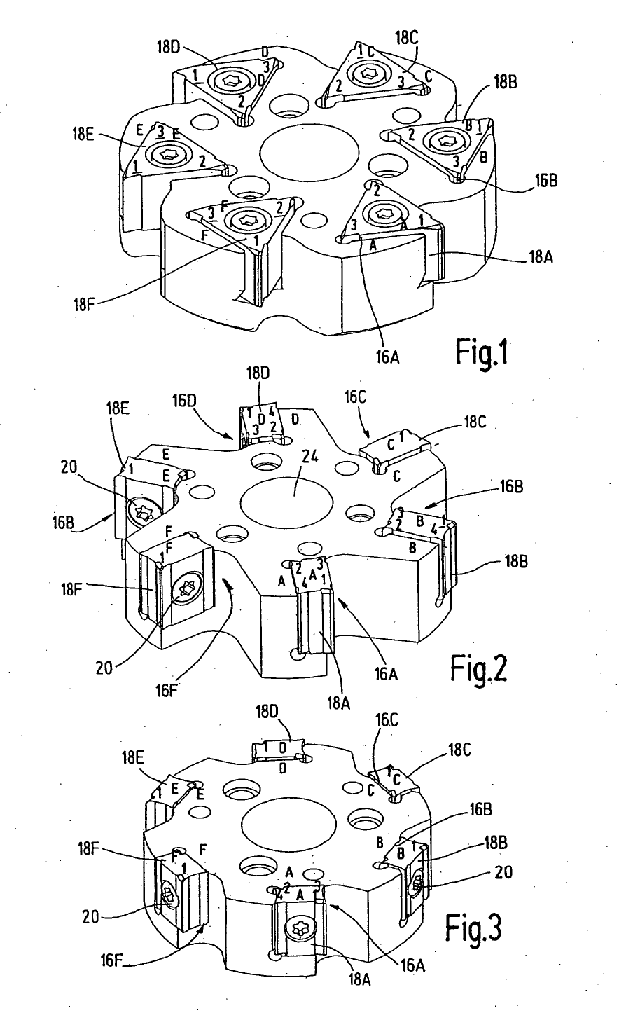

FIG. 1 shows a diagrammatic representation of a cutting ring having reversible plates that are triangular in horizontal projection;

FIG. 2 shows a diagrammatic representation of a cutting ring having reversible plates, mounted in the circumferential direction, that are rectangular in horizontal projection;

FIG. 3 shows a diagrammatic representation of a cutting ring having radially mounted reversible plates that are quadrangular in horizontal projection;

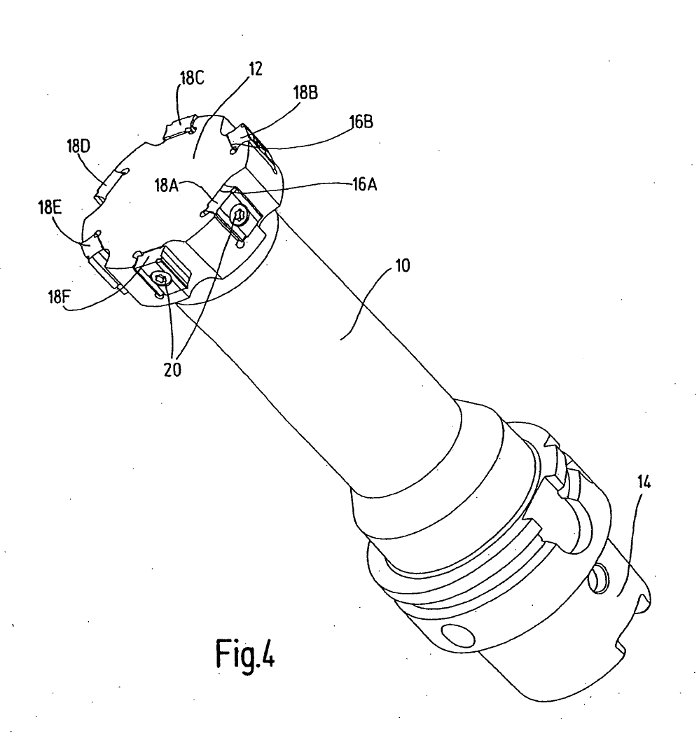

FIG. 4 shows a machine tool having a cutting ring according to FIG. 3;

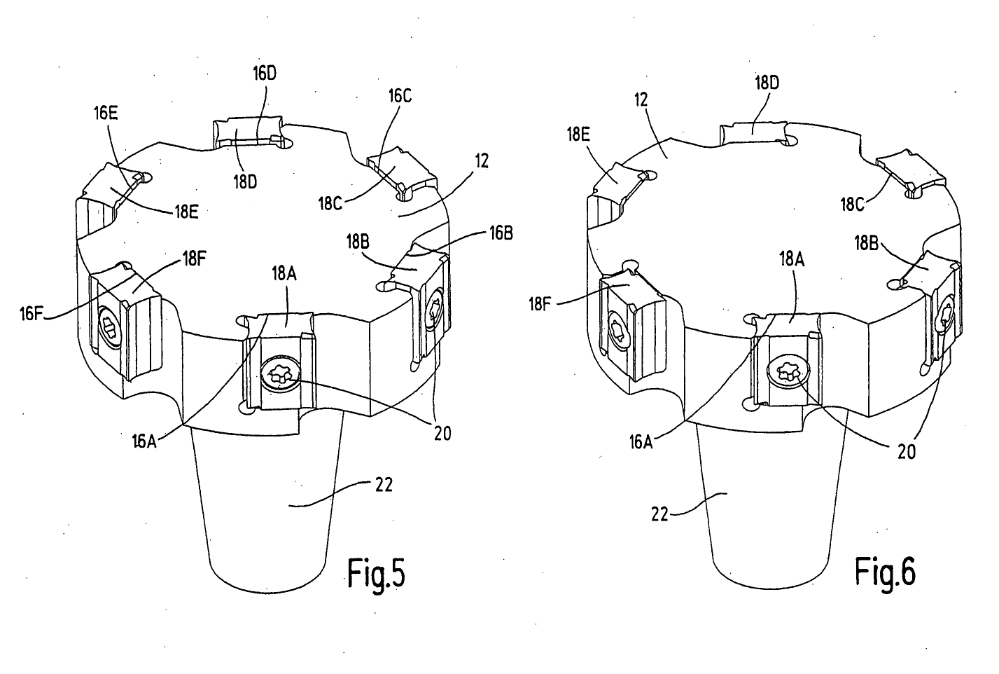

FIG. 5 shows a cutting ring according to FIG. 3, having a tapered clamping shaft;

FIG. 6 shows an exemplary embodiment, modified in relation to FIG. 5, having two groups of reversible plates;

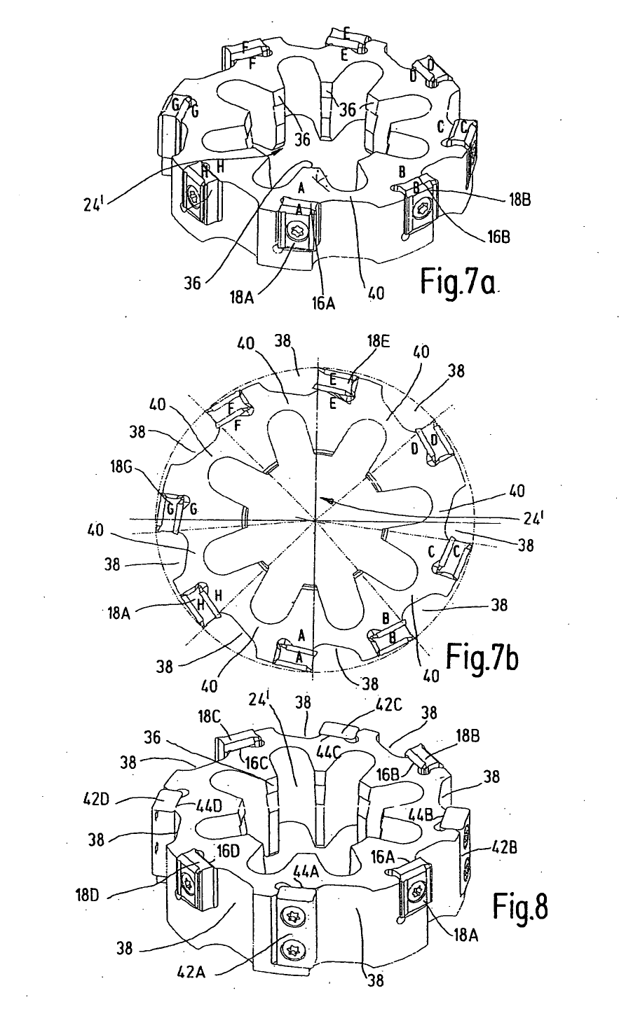

FIGS. 7a and b show a diagrammatic representation and a top view of a cutting ring having a spreading rosette and rectangular reversible plates of the same type;

FIG. 8 shows a diagrammatic representation of a cutting ring having a spreading rosette, a group of cutting plates and a group of support plates;

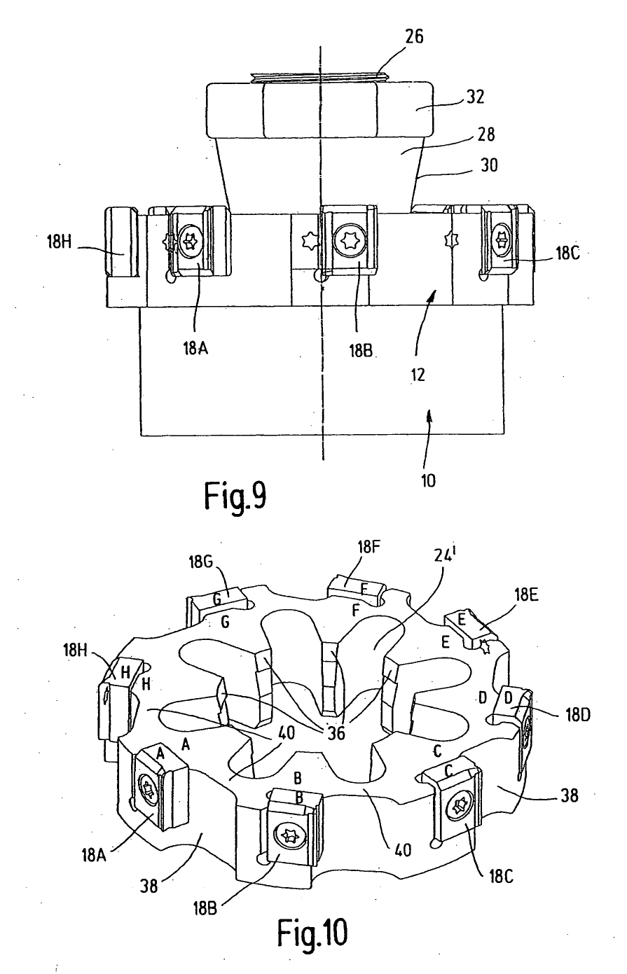

FIG. 9 shows a side view of a machine tool having a cutting ring and spreading device;

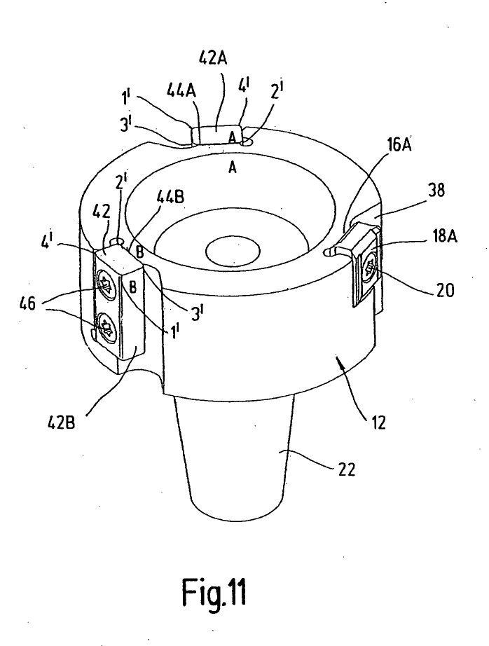

FIG. 10 shows the cutting ring, having a spreading rosette, of the machine tool according to FIG. 9;

FIG. 11 shows a diagrammatic representation of a cutting ring according to FIG. 5, having a cutting plate and a group of support plates.

Shown exemplarily in FIG. 4 is a machine tool, realized as a reaming tool, which, in the front portion of a tool holder 10, carries a detachably fastened cutting ring 12 and, at its back end, is provided with a coupling element 14 for connection to a machine spindle.

In the case of the exemplary embodiment shown in FIG. 4, the cutting ring 12 has 6 plate seats 16 A-F, arranged at a distance from one another in the circumferential direction, which are fitted, respectively, with a reversible plate 18 A-F realized as a cutting plate. The reversible plates 18 A-F are fixed to the plate seats 16 A-F of the cutting ring 12 by means of radially aligned countersunk-head screws. The reversible plates 18 A-F are arranged in this case such that they have an alternate axial and radial offset in relation to one another, and thereby constitute a first group, composed of the reversible plates 18 A,C,E, and a second group, composed of the reversible plates B,D,F. The reversible plates have the form of a straight prism, having a substantially rectangular basic surface, on whose peripheral edges, which project perpendicularly over the basic surface, the working edges 1,2,3,4, realized as cutting edges, are formed-in. Each individual reversible plate 18 A-F can be reversed and/or turned, and thereby rearranged, by undoing the countersunk-head screws 20.

A cutting ring 12 carrying a tapered tool shaft is likewise provided in the case of the tools shown in FIGS. 5 and 6. There, likewise, reversible plates 18 A-F, realized as cutting plates, are fastened in plate seats 16 A-F in the cutting ring 12 by means of radially aligned countersunk-head screws 20. In the case of the exemplary embodiment shown in FIG. 6, as in the case of FIG. 4, there are arranged two groups of reversible plates 18 A,C,E and 18 B,D,F, which are arranged such that they have a slight alternate axial and radial offset in relation to one another. In the case of FIG. 5, all reversible plates 18 A-F are located on the same level on the cutting ring 12, and thereby constitute only one group of reversible plates of the same type.

The cutting rings 12 are produced independently of their tool shafts 10,22, and machine-finished and fitted with the reversible plates. In the case of the exemplary embodiments according to FIGS. 1 to 3, the cutting rings 12 are represented in a state in which they have been separated from the tool shaft 10,22. The cutting ring according to FIG. 3 in this case corresponds in its structure to the cutting ring according to FIG. 5.

In the case of the exemplary embodiment according to FIG. 1, the reversible plates 18 A-F have the form of a straight prism having a triangular basic surface, into whose peripheral edges, which are perpendicular to the basic surface, the working edges 1,2,3 realized as cutting edges are formed. The plate seats 16 A-F match the triangular outline shape of the reversible plates 18. The reversible plates according to FIG. 1 are fixed in the cutting ring by means of axially aligned countersunk-head screws.

In the case of the exemplary embodiment according to FIG. 2, as in the case of FIG. 3, the reversible plates 18 A-F have the form of a straight prism having a rectangular basic surface, the four working edges 1,2,3,4, realized as cutting edges, being formed into the peripheral edges of the prism that project perpendicularly over the basic surface. In the cutting ring 12 according to FIG. 2, the plate seats 16 A-F are aligned with their base in the circumferential direction. Accordingly, the reversible plates 18 A-F are fixed there to the cutting ring 12, in their plate seats 16 A-F, by means of countersunk-head screws 20 aligned in the circumferential direction.

In the case of the cutting rings 12 according to FIGS. 1 to 3, the reversible plates 18 A-F constitute a group, and they have the same positioning in their plate seats 16 A-F in the radial and axial directions.

The production and assembling of the cutting rings according to FIGS. 1 to 3 are performed in the following sequence:

Firstly, the basic body of the cutting ring 12 is finished machined. In a soft machining operation, it acquires the necessary contour with the plate seats and the threaded bores for the countersunk-head screws 20. It is then subjected to thermal treatment, following which the receiving bore 24 is ground. The individual plate seats 16 A-F are inscribed with the addresses A-F.

The reversible plates are then prepared, which reversible plates are identified with the letters A-F for unique assignment to individual plate seats 16 A-F. In addition, the individual working edges are inscribed with numbers 1 to 4, such that cutting-edge assignment is possible in the case of the various reversible plates.

The grinding of the reversible plates is effected in a group-wise manner, in that the reversible plates 18 A-F belonging to a group are inserted in the associated plate seats 16 A-F such that, in each case, the working edge 1 of all insert plates is first ground jointly to nominal size. The reversible plates 18 A-F are then rearranged within the associated plate seats 16 A-F, such that the working edge 2 comes into the operative position. In this position, the working edges 2 of all reversible plates are ground to nominal size. This process is continued until the final working edges of the reversible plates of a group have been ground to nominal size. If there are several groups of reversible plates, as in the case of the exemplary embodiments according to FIGS. 4 and 6, the grinding process is repeated in the same sequence for the reversible plates of the other groups.

The cutting ring or the tool is then supplied in an assembled state to the customer. In the case of wear of the working edges, the customer can himself rearrange the reversible plates in the associated plate seats, retaining the assignments A,B,C, . . . and 1,2,3 . . . in the plate seats.

When all working edges are worn off or worn out, the user sends the basic body of the cutting ring 12 to the manufacturer, who can then calibrate a further set of reversible plates. The customer can use a further cutting ring, fitted with plates, to bridge the time required for this operation.

The exemplary embodiment of a machine tool shown in FIG. 9 offers a further adjustment possibility in the case of wear. There, the tool holder 10 carries a threaded stem 26, which projects centrally at an end face and onto which a spreading body 28 can be clamped, via an external taper 30, by means of a threaded nut 32, with intermediate clamping of the cutting ring 12. As can be seen from FIG. 10, as well as FIGS. 7 a,b and 8, the cutting ring 12 in this case has a recess 24′, realized in the manner of a rosette, which is delimited inwardly by a plurality of support elements 36 that complement one another to form an internal taper and that are assigned to the individual plate seats 16 A-H, and between which there are arranged elastically spreadable wall portions 40 of lesser wall thickness that extend in the circumferential direction and that are assigned to the individual chip grooves 38. In the assembled state, the spreading body 28 bears, via its external taper 30, against the support elements 36 of the cutting ring 12. The cutting ring can be dilated elastically through elastic spreading in the region of the wall portions 40. Since the elastic spreading is reversible, there is a definite correspondence between the rotational angle of the threaded nut 32 and the radial expansion achieved thereby.

In the case of the exemplary embodiment according to FIGS. 7a and b, the cutting ring has a group of eight plate seats 16 A-H and reversible plates 18 A-H, having radially aligned countersunk-head screws 20, distributed over the circumference.

The exemplary embodiment according to FIG. 8 shows a group of four reversible plates 18 A to D of the same type, realized as cutting plates, and a further group, of four reversible plates 42 A-D of the same type, realized as support plates, which are arranged in plate seats 16 A-D and 44 A-D and whose cutting and support edges are factory-ground to nominal size in a group-wise manner, separately from one another.

In the case of the exemplary embodiment shown in FIG. 11, the cutting ring 12 has a total of three plate seats, of which the plate seat 16A is fitted with a reversible plate 18A, realized as a cutting plate, and the seats 44A and B are fitted with two reversible plates 42A, 42B, realized as support plates, which belong to a group. The reversible plate 16a has four working edges, realized as cutting edges, while the reversible plates 42A and B has four working edges 1′,2′,3′,4′, realized as support edges. The reversible plate 16 is fixed to the cutting ring by a central, radially aligned countersunk-head screw 20, while the reversible plates 42A and B are fastened to the cutting ring by two countersunk-head screws 46. The reversible plates 42A,B realized as support plates are each ground over jointly to nominal size on their four working edges 1′,2′,3′,4′, with the reversible plate 16A having been removed, while the reversible plate 16A realized as a cutting plate are ground over to nominal size on its four working edges, realized as cutting edges, the reversible plates 42A and B having been removed. In the case of wear of the cutting edges of the various reversible plates, the reversible plates 42A and B that are realized as support plates are rearranged jointly, in a group-wise manner; in their plate seats, while the reversible plate 16A can be rearranged independently thereof.

FIGS. 8 and 11 illustrate that both cutting plates and support plates, which are each realized as reversible plates, constitute plate groups within the meaning of the invention, and can be ground-in and rearranged in their home plate seats in a group-wise manner.

The following may be stated in summary: The invention relates to a machine tool for use in tool machines, comprising a cutting body, which is preferably realized as a cutting ring 12, and at least two plate seats at a distance from one another in the circumferential direction in the cutting body. The plate seats are fitted with at least one group of at least two insert plates of like realization that are detachably arranged there and that each have at least one working edge, the operative working edges of the insert plates of a group being ground to the same nominal size. The invention consists, in essence, in that the insert plates are realized as reversible plates 18 A-F, each individual reversible plate of a group is assigned to a defined plate seat 16 A-F in all positions of change, and the reversible plates of a group each have at least two working edges 1,2,3,4, of which, depending on the position of the reversible plates 18 A-F in the associated plate seats 16 A-F, in each case one is in an operative position and at least one other is in a non-operative position. The reversible plates 16 A-F of a group assume mutually corresponding positions of change, in which defined working edges of each reversible plate of a group have the same orientation within the associated plate seat 16 A-F, the working edges 1,2,3,4 of the reversible plates of a group being ground to nominal size in all common positions of change. As a result of these measures, both the production and the plate changing are facilitated, and the plate changing can be performed at the user's premises.

1. A machine tool for use in tool machines, comprising a cutting body (12), which is preferably realized as a cutting ring, at least two plate seats (16, 44) at a distance from one another in the circumferential direction in the cutting body, at least one group of at least one insert plate (18, 42) that is detachably arranged in the plate seats and that has at least one working edge (1 to 4), the at least one working edge of the at least one insert plate of a group being ground to a predefined nominal size, characterized in that the insert plates are realized as reversible plates (18, 42), each individual reversible plate of a group is assigned to a defined plate seat (16, 44) in all positions of change, the reversible plates of a group each have at least two working edges (1 to 4, 1′ to 4′), of which, depending on the position of the reversible plates in the associated plate seats (16, 44), in each case one is in an operative position and at least one other is in a non-operative position, all reversible plates of a group having a plurality of reversible plates assume mutually corresponding positions of change, in which defined working edges (1 to 4, 1′ to 4′) of each reversible plate (18, 42) of the respective group have the same orientation within the associated plate seat (16, 44), and the working edges (1 to 4, 1′ to 4′) of the reversible plates of a group are ground to nominal size in all common positions of change.

2. The machine tool as claimed in claim 1, characterized in that the reversible plates (16) of a group are realized as cutting plates, and their working edges (1 to 4) are realized as cutting edges.

3. The machine tool as claimed in claim 1 or 2, characterized in that the reversible plates (42) of a group are realized as support plates, and the working edges (1′ to 4′) are realized as support edges.

4. The machine tool as claimed in any one of claims 1 to 3, characterized in that the working edges (1 to 4, 1′ to 4′) of the reversible plates (18, 42) of a group are surface-coated in all common positions of change.

5. The machine tool as claimed in any one of claims 1 to 4, characterized in that the reversible plates (18, 42) of a group and the plate seats (16, 44) are identified correspondingly in respect of their mutual assignment.

6. The machine tool as claimed in any one of claims 1 to 5, characterized in that the working edges (1 to 4, 1′ to 4′) of the reversible plates (18, 42) of a group are identified correspondingly in respect of their mutual assignment.

7. The machine tool as claimed in any one of claims 1 to 6, characterized in that the cutting body is realized as a cutting ring (12) having plate seats (16, 44) arranged in a distributed manner over its circumference.

8. The machine tool as claimed in any one of claims 1 to 7, characterized in that the reversible plates (18, 42) have, in essence, the form of a straight prism, on whose lateral edges, which are perpendicular to a basic surface, the working edges (1 to 4, 1′ to 4′) are formed-in.

9. The machine tool as claimed in claim 8, characterized in that the reversible plates (18) have the form of a prism having a basic surface of an isosceles triangle.

10. The machine tool as claimed in claim 8, characterized in that the reversible plates (18, 42) have the form of a prism having a rectangular or square basic surface.

11. The machine tool as claimed in claim 10, characterized in that the mutually adjacent working edges of the reversible plates (18) are oriented such that they are laterally reversed in pairs in relation to one another.

12. The machine tool as claimed in any one of claims 1 to 11, characterized in that the reversible plates (18, 42) are fixed to the cutting body, or cutting ring (12), by at least one headed screw, preferably realized as a countersunk-head screw (20, 46).

13. The machine tool as claimed in claim 12, characterized in that the headed screws (20, 46) are screwed into radially aligned threaded bores of the cutting body or of the cutting ring (12).

14. The machine tool as claimed in claim 12, characterized in that the headed screws (20) are screwed into threaded bores of the cutting body or of the cutting ring (12) that are aligned in the circumferential direction.

15. The machine tool as claimed in claim 12, characterized in that the headed screws (20) are screwed into threaded bores of the cutting body or of the cutting ring (12) that have an axially parallel alignment.

16. The machine tool as claimed in any one of claims 1 to 15, characterized in that the cutting body, realized as a cutting ring (12), has a central, preferably tapered spreading device for spreading the cutting ring.

17. The machine tool as claimed in claim 16, characterized in that the cutting ring (12) has support elements (36) that complement one another to form an internal taper and that are assigned to the individual plate seats (16, 44), and between which there are arranged elastically spreadable wall portions (40) of lesser wall thickness that extend in the circumferential direction and that are assigned to individual chip grooves (38), and there is provided a spreading body (28), which clamps the cutting ring (12) against a tool holder (10) and bears against the support elements (36) via an external taper (30).

18. The machine tool as claimed in claim 17, characterized by a threaded nut (32), which can be screwed onto a central threaded stem (26) that is solid with the tool holder and which clamps the spreading body (28) against the cutting ring (12).

19. The machine tool as claimed in any one of claims 1 to 18, characterized in that the cutting body (12) has plate seats for at least one further group of reversible plates of like realization, whose operative working edges are ground to nominal size in their positions of change.

20. A cutting ring for a machine tool, comprising at least two plate seats (16, 44) at a distance from one another in the circumferential direction, and at least one group of at least two insert plates of like realization that are detachably arranged in the plate seats and that each have at least one working edge, the working edges of the insert plates of a group being ground to the same nominal size, characterized in that the insert plates are realized as reversible plates (18, 42), each individual reversible plate (18, 42) of a group is assigned to a defined plate seat (16, 44) in all positions of change, the reversible plates (18, 42) of a group each have at least two working edges (1 to 4, 1′ to 4′), of which, depending on the position of the reversible plates in the associated plate seats (16, 44), in each case one is in an operative position and at least one other is in a non-operative position, all reversible plates of a group having a plurality of reversible plates assume mutually corresponding positions of change, in which defined working edges (1 to 4, 1′ to 4′) of each reversible plate (18, 42) of the respective group have the same orientation within the associated plate seat (16, 44), and the working edges of the reversible plates of a group are ground to nominal size in all common positions of change.

21. The cutting ring as claimed in claim 20, characterized in that the reversible plates (16) of a group are realized as cutting plates, and their working edges (1 to 4) are realized as cutting edges.

22. The cutting ring as claimed in either of claim 20 or 21, characterized in that the reversible plates (42) of a group are realized as support plates, and the working edges (1′ to 4′) are realized as support edges.

23. The cutting ring as claimed in any one of claims 20 to 22, characterized in that the working edges of the reversible plates (18, 42) of a group are surface-coated in all common positions of change.

24. The cutting ring as claimed in any one of claims 20 to 23, characterized in that the reversible plates (18, 42) of a group and the plate seats (16, 44) are identified correspondingly in respect of their mutual assignment.

25. The cutting ring as claimed in any one of claims 20 to 24, characterized in that the working edges (1 to 4, 1′ to 4′) of the reversible plates (18, 42) of a group are identified correspondingly in respect of their mutual assignment.

26. The cutting ring as claimed in any one of claims 20 to 25, characterized in that the reversible plates (18, 42) have, in essence, the form of a straight prism, on whose lateral edges, which are perpendicular to a basic surface, the working edges (1 to 4, 1′ to 4′) are formed-in.

27. The cutting ring as claimed in claim 26, characterized in that the reversible plates (18) have the form of a prism having a basic surface of an isosceles triangle.

28. The cutting ring as claimed in claim 26, characterized in that the reversible plates (18, 42) have the form of a prism having a rectangular or square basic surface.

29. The cutting ring as claimed in claim 28, characterized in that the mutually adjacent working edges of the reversible plates (18) are oriented such that they are laterally reversed in pairs in relation to one another.

30. The cutting ring as claimed in any one of claims 20 to 29, characterized in that the reversible plates (18, 42) are fixed by at least one headed screw, preferably realized as a countersunk-head screw (20, 46).

31. The cutting ring as claimed in claim 30, characterized in that the headed screws (20, 46) are screwed into radially aligned threaded bores.

32. The cutting ring as claimed in claim 30, characterized in that the headed screws (20) are screwed into threaded bores that are aligned in the circumferential direction.

33. The cutting ring as claimed in claim 30, characterized in that the headed screws (20) are screwed into threaded bores that have an axially parallel alignment.

34. The cutting ring as claimed in any one of claims 30 to 33, characterized by a central spreading device.

35. The cutting ring as claimed in claim 34, characterized by a plurality of support elements (36) that complement one another to form an internal taper and that are assigned to the individual plate seats (18, 42), and between which there are arranged elastically spreadable wall portions (40) of lesser wall thickness that extend in the circumferential direction and that are assigned to individual chip grooves (38).

36. The cutting ring as claimed in any one of claims 20 to 35, characterized in that there are provided plate seats for at least one further group of reversible plates of like realization, whose working edges are ground to nominal size in their operative positions of change.
